(19) United States
(12) Patent Application Publication
(10) Pub. No.: US 2020/0350523 A1
(43) Pub. Date: Nov. 5, 2020

(54) BATTERY HOUSING

(71) Applicant: Mahle International GmbH, Stuttgart (DE)

(72) Inventors: Johannes Weinmann, Stuttgart (DE); Tilman Kaiser, Leinfelden-Echterdingen (DE); Peter Nowak, Stuttgart (DE)

(21) Appl. No.: 16/865,300

(22) Filed: May 1, 2020

(30) Foreign Application Priority Data
May 3, 2019 (DE) 102019206398.5
Jul. 5, 2019 (DE) 102019209956.4

(51) Int. Cl. H01M 2/02; B60L 50/64; H01M 2/10

(52) U.S. Cl. CPC H01M 2/0245; B60L 50/64; H01M 2220/20; B60Y 2410/10; H01M 2/1083

(57) ABSTRACT

The battery housing may include a first housing part and a second housing part. The first housing part and the second housing part may be connectable to one another in a sealing manner. At least one housing part of the first housing part and the second housing part may include a base region and a lateral wall region that adjoins the base region such that the at least one housing part is tray-shaped. The lateral wall region may have an internal side and an external side. An encircling flange may be arranged on the lateral wall region of the at least one housing part. A separately structured reinforcement structure may be arranged on the lateral wall region between the flange and the base region.

### CROSS-REFERENCE TO RELATED APPLICATIONS

This application claims priority to German Patent Application No. DE 10 2019 209 956.4, filed on Jul. 5, 2019, and German Patent Application No. DE 10 2019 206 398.5, filed on May 3, 2019, the contents of both of which are hereby incorporated by reference in their entirety.

### TECHNICAL FIELD

The present invention relates to a battery housing, in particular for a battery system for driving a vehicle. The invention moreover relates to a battery system having such a battery housing.

### BACKGROUND

Battery housings for battery systems for driving vehicles are known. Accumulator cells which can receive and discharge electric energy are arranged in the battery housings. In addition to the accumulator cells, the electrical contacts are also usually arranged within the battery housing. The accumulator cells and the contacts thereof are usually embodied as cell modules, wherein a plurality of cell modules are inserted into a battery housing. The battery housing has in particular the task of protecting the cell modules against mechanical damage. To this end, there are also requirements of the vehicle manufacturers with a view to guaranteeing the crash safety and the crush safety of the battery system.

### SUMMARY

Accordingly, it is an object of the present invention to specify improved or at least other embodiments for a battery housing of the type mentioned at the outset as well as for a battery system having such a battery housing, said embodiments being in particular distinguished by improved safety.

This object is achieved according to the invention by the subject matter of the independent claim(s). Advantageous embodiments are the subject matter of the dependent claim(s).

The present invention is based on the general concept of providing on a tray-shaped housing part of a battery housing, in which accumulator cells are received and which has a base region and a lateral wall region as well as a flange, a separate reinforcement structure between the flange and the base region. The reinforcement structure leads to an increased mechanical stability and/or reinforcement of the housing part. The housing part and thus the battery housing are consequently mechanically reinforced and stabilized. The battery housing is in particular stabilized in relation to influences of forces which can arise in the event of an accident and/or at high internal pressures, for example. This leads to improved safety of the battery housing and of the associated battery system. The accumulator cells received in the battery housing are in particular better protected and secured. The separate design embodiment of the reinforcement structure allows the tray-shaped housing part to be provided with the reinforcement structure in a simplified and flexible manner adapted to requirements. The production costs of the battery housing are consequently reduced.

The battery housing according to the invention is in particular provided for use in a battery system for driving a vehicle. To this end, the battery housing has a first and a second housing part. The housing parts delimit an internal volume within the battery housing. The housing parts are connectable to one another in a sealing manner, or in the completed battery housing or battery system are connected to one another in a sealing manner, respectively, in particular such that no dirt can invade the housing, on the one hand, and no liquid contained in the battery housing, such as a coolant, for example, can leak from said housing. The housing parts are preferably connected to one another in a releasable manner, in particular screw-fitted or snap-fitted to one another. This allows simplified access to the internal volume of the battery housing when required, for example in the case of servicing. Alternatively, the housing parts can also be connected to one another in a non-releasable manner, for example by welding, adhesive bonding, or crimping. At least one of the housing parts is configured so as to be tray-shaped and possesses the base region and the lateral wall region, the latter at one end adjoining the base region. A flange for connecting the housing parts to one another is provided on the tray-shaped housing part. The flange of the one housing part is connectable to a counter contour of the other housing part. The counter contour herein may likewise be a flange or a receptacle. In order for the mechanical rigidity to be increased so as to adhere to the crash and/or crush requirements, a reinforcement structure which is embodied separately from the tray-shaped housing part is arranged in the lateral wall region. Said reinforcement structure is connected to the lateral wall region between the base region and the flange.

Separately embodied presently means that the reinforcement structure is produced separately from the associated tray-shaped housing part and is subsequently attached to the latter.

A seal for forming a sealing connection is arranged between the housing parts. The seal bears on sealing faces. The sealing faces are in particular configured on the flange such that the flange preferably furthermore is used for sealing the battery housing.

The seal preferably runs so as to be axially and/or radially offset from the reinforcement structure. The same preferably applies in an analogous manner to the sealing faces.

The accumulator cells serve in each case for receiving and discharging electric energy. These are thus in particular rechargeable accumulator cells. The respective accumulator cell may be a galvanic accumulator cell. The respective accumulator cell is in particular a pouch cell or a prismatic cell.

The housing parts may be formed, or produced, respectively, from metal such as, for example, aluminium or other metal, or from an alloy such as, for example, steel. Alternatively, the housing parts may also be formed, in particular as a plastics-material tray, from a plastics material, for example a thermoplastic material or a thermosetting plastics material which can be processed by the injection-moulding method. The housing parts may also be formed a hybrid parts from plastics material and a metal and/or a metal alloy.

The lateral wall region expediently has at least one wall which projects from the base region, wherein the walls can run in a mutually inclined manner so as to circumferentially delimit the internal volume in a circumferential direction. It is conceivable herein for the base region and the lateral wall region, in particular the walls, to be produced in a materially integral manner.

The tray-shaped housing part, conjointly with the base region and the lateral wall region, in particular also the flange region, is preferably formed from a thin, in particular formed, sheet-metal part. The weight of the component can thus be kept low.

In housing parts from metal the battery housing may have fastening structures for fixing the battery housing and thus also the associated battery system to a vehicle body of the associated vehicle. Furthermore, the electromagnetic compatibility, in particular the EMC protection, can simply be incorporated in the battery housing. Moreover, a battery housing from metal has good flame proofing.

The base region is advantageously configured as a flat face, wherein structures for reinforcing the surface or for fixing components of the associated battery system, in particular the accumulator cells, which are arranged in the battery housing may be provided.

The lateral wall region delimits the internal volume in the region of the associated tray-shaped housing part along a height direction which runs in the direction of the other housing part. To this end, the lateral wall region preferably has an internal side and an external side which run in each case along the height direction. The internal side faces the internal volume, whereas the external side faces away from the internal volume.

It is advantageous for the reinforcement structure to be embodied in segments. The reinforcement structure thus has at least two separate segments which hereunder are also referred to as segment elements, is in particular composed of the segment elements. By virtue of the minor component size of the individual segments the reinforcement structure is thus simple to produce and by way of the segments readily adaptable to different battery housing sizes, since the number of segments to be used may be variable, for example.

In principle, segments which are individually adapted to the respective lateral wall region, or to the respective wall, respectively, can be used for different lateral wall regions and/or for different walls of the respective lateral wall region. An adaptation to different lateral wall regions, or walls, respectively, can thus also be achieved by using the dissimilarly configured segments.

The segments of the reinforcement structure are preferably configured as common parts. This allows the same segments and thus common parts to be used the lateral wall regions in the longitudinal direction, or transverse direction, respectively, as well as on the internal side and on the external side. The production costs can be reduced, and the storage and parts supply can be optimized by using common parts.

According to one particular design embodiment, the reinforcement structure can be arranged on the internal side of the lateral wall region and/or on the external side of the lateral wall region. The lateral wall region is thus imparted additional stability.

It is in particular conceivable for the reinforcement structure in part to be arranged on the internal side and in part to be arranged on the external side of the lateral wall region. This preferably takes place by disposing at least one segment of the reinforcement structure on the internal side and disposing at least one segment of the reinforcement structure on the external side. This leads to an increased mechanical stability of the associated housing part in relation to the influences of forces from the outside to the inside. This moreover also results in stabilizing the associated housing parts in mechanical terms in relation to influences of forces from the inside to the outside. At least two of the segments can in particular be arranged so as to be directly opposite on the internal side and on the external side of the lateral wall region.

In advantageous embodiments the reinforcement structure, in particular at least one segment, possesses corrugations which can be configured as depressions or elevations. The reinforcement structure is thus imparted a higher degree of inherent rigidity. The corrugations are simple to incorporate on account of the reinforcement structure being embodied separately from the tray-shaped housing part, so that the production costs are reduced. In particular, the corrugations can be incorporated in a simpler manner in the state attached to the housing part, wherein deformations of the lateral wall region and/or of the base region caused by the incorporation of the corrugations are prevented or at least reduced. The corrugations may be arranged in peripheral zones and/or central regions of the reinforcement structure. The corrugations herein may have arbitrary contours. Said contours can preferably be configured so as to be oval or elliptic.

In advantageous design embodiments of the invention the reinforcement structure is connected in a non-releasable manner, particularly preferably in a materially integral manner, in particular by welding, adhesive bonding, soldering/brazing, to the lateral wall region. Other mechanical connections such as riveting and screwing are also conceivable. A direct flux of force between the lateral wall region and the reinforcement structure takes place on account of the non-releasable connection. The mechanical stability of the battery housing, in particular in relation to influences of forces, is consequently improved. Moreover, any inadvertent removal of the reinforcement structure is precluded, or the risk thereof is at least reduced. In the case of materially integral connections there is furthermore the resultant advantage that leakages created on account of the connection are thus prevented or at least reduced.

As an alternative to the non-releasable connection, the reinforcement structure could potentially also be connected in a releasable. This embodiment can be advantageous when more working space has to be made available for the assembling, for example. Moreover, components from dissimilar materials can be more easily connected to one another.

According to one advantageous design embodiment, the tray-shaped housing part and the reinforcement structure are formed from the same material. Both components thus possess comparable mechanical and chemical properties, which facilitates the basic design of the components. Furthermore, components from identical materials can be more easily connected to one another, for example by welding or soldering/brazing.

In one advantageous design embodiment of the invention the reinforcement structure, in particular at least one segment of the reinforcement structure, advantageously the respective segment, possesses two legs which are mutually arranged at an angle. The legs can be connected to one another in a materially integral manner, for example by forming, or bending, respectively, a sheet-metal part along a bending radius. Alternatively, an intermediate piece which is fixedly connected to both legs could potentially also be arranged between the legs. The legs may possess identical or dissimilar lengths. A configuration of the reinforcement structure, in particular of the at least one segment, leads to an improved absorption of force by the reinforcement structure and thus to improved mechanical stability. Moreover, the reinforcement structure can thus better dissipate acting forces by way of plastic or elastic deformation. Overall, this thus results in improved mechanical stability as well as in improved protection of the components, in particular of the accumulator cells, received in the battery housing.

The angle arranged between the legs can be embodied as an acute angle, an obtuse angle, or a right angle. The reinforcement structure is more rigid in embodiments having an acute angle, thus angles of less than 90°, in particular between 45° and 90°, between the legs. Greater forces can thus be absorbed in the bending radius. Facilitated deformation can be achieved in embodiments having an obtuse angle, thus angles between 90° and 180°, in particular between 95° and 130° , on account of which introduced forces can be better dissipated by way of deformation, the interior of the battery housing thus being better protected.

It is of course conceivable that the angle between the legs varies along the lateral wall region so as to provide locally dissimilar, adapted, properties of the reinforcement structure. This can be achieved in particular by using dissimilarly configured segments of the reinforcement structure.

According to one particularly advantageous embodiment, the lateral wall region is arranged at an angle of more than 90° in relation to the base region. This means in particular that the plane of extent of the base region conjointly with the plane of extent of the lateral wall region forms an angle of more than 90°. The tray shape of the housing along the lateral wall region is thus enlarged. This leads to a significantly simplified production of the housing part.

If the reinforcement structure has two legs of said type, it is alternatively or additionally preferable for the reinforcement structure at least in part to be arranged on the external side on the housing part, in particular on the external side of the lateral wall region. The reinforcement structure in the part arranged on the external side is advantageously designed in such a manner that one of the legs, in particular the base-proximal leg, runs along the base region. The other leg adjoins the lateral wall region close to the flange, in particular in the region of the flange, and is advantageously spaced apart from the flange. The forces acting from the outside can thus be dissipated in an improved manner, in particular without any influence of force on the components, for example the accumulator cells, received in the battery housing. The disposal of the legs as to be spaced apart from the flange furthermore leads to a deformation of the flange caused by the absorption of force being at least reduced. An absorption of force by way of the reinforcement structure thus takes place at an at least reduced risk of the connection of the housing parts being released. This leads to improved protection of the components, in particular the accumulator cells, received in the battery housing.

It is understood that, apart from the battery housing, a battery system having such a battery housing is also a subject matter of this invention.

The battery system, apart from the battery housing, has at least one accumulator cells which is arranged in the battery housing.

The battery system advantageously has at least one cell module in which at least two accumulator cells are arranged and electrically wired to one another.

The battery system preferably has at least two, particularly preferably at least more than two, for example up to twelve cell modules arranged in the battery housing. Variants having more than twelve cell modules are also conceivable. The provision of the cell modules allows simple scaling of the dimensions of the battery housing and of the battery system and/or simple adaptation to the output requirements set for the battery system. Moreover, individual cell modules can be exchanged and/or replaced in a simplified manner when required, in particular in the case of damage.

The respective cell module preferably has a module housing or a module frame which receives, in particular encloses, the accumulator cells. The attaching of the cell module to the battery housing and/or the fixing of the cell module in the battery housing expediently takes place by way of the module housing. For this purpose, the module housing can be correspondingly shaped and/or configured, in particular have mouldings, clearances, and the like.

The respective module housing can be configured in multiple parts. In particular, the module housing can have at least one end plate which is arranged at the end side of the accumulator cells. The module housing preferably has two such end plates which lie opposite one another and between which the accumulator cells are arranged. The respective end plate can fix and/or pre-tension the accumulator cells within the cell module.

The module housing can in principle be produced from any arbitrary material. The module housing at least in part is in particular produced from plastics material, advantageously entirely also plastics material.

If two or more cell models are provided, at least two of the cell modules can be combined so as to form one pair of cell modules and be conjointly arranged in the housing. Variants in which at least one such pair and at least one single such cell module are arranged in the housing are conceivable.

It is likewise possible for a group of cell modules to be combined and arranged on the housing. At least three cell modules which in mechanical terms are arranged in parallel or in series are provided in the respective group. Groups in which part of the cell modules in mechanical terms are arranged in parallel and other cell modules in mechanical terms are arranged in series are also conceivable. The cell modules of the respective group herein can be electrically wired to one another in an arbitrary manner. A flow path of the temperature-controlling means, in particular of a coolant, preferably leads through the battery housing. In operation, temperature-controlling, in particular cooling, of the components, in particular the accumulator cells or the cell modules, respectively, of the battery system that are arranged in the battery housing takes place by the temperature-controlling means.

The battery system in the battery housing advantageously has components which delimit, or define, respectively, the flow path. At least one of the module housing can belong to said components. Alternatively or additionally, at least one duct element which delimits, or defines, respectively, the flow path is arranged in the battery housing. At least one of the duct elements, advantageously the respective duct element, is preferably at least in part, in particular entirely, produced from plastics material. Alternatively, the respective duct element can be produced from aluminium or an aluminium alloy. Hybrid construction modes in which the respective duct element is produced from plastics material and from aluminium or an aluminium alloy are also conceivable.

Further important features and advantages of the invention are derived from the dependent claims, from the drawings, and from the associated description of the figures by means of the drawings.

It is understood that the features mentioned above and yet to be explained hereunder can be used not only in the respective stated combination but also in other combinations or individually without departing from the scope of the present invention.

Preferred exemplary embodiments of the invention are illustrated in the drawings and will be explained in more detail in the description hereunder, wherein identical reference signs refer to identical or similar or functionally equivalent components.

### BRIEF DESCRIPTION OF THE DRAWINGS

Herein, in each case in a schematic manner:

FIG. 1 shows an isometric of a battery system having a first housing part of a battery housing having cell modules arranged therein;

FIG. 2 shows an isometric view of a cell module of the battery system from FIG. 1;

FIG. 3 shows an isometric view of the first housing part in another exemplary embodiment;

FIG. 4 shows a fragment of an isometric view of the first housing part in the region of a lateral wall region having a reinforcement structure;

FIG. 5 shows an isometric view of the first housing part in another exemplary embodiment;

FIG. 6 shows a fragment of a plan view onto the first housing part from FIG. 5;

FIG. 7 shows a fragment of a section through the battery housing; and

FIG. 8 shows the view from FIG. 7 in a further exemplary embodiment of the battery system.

### DETAILED DESCRIPTION

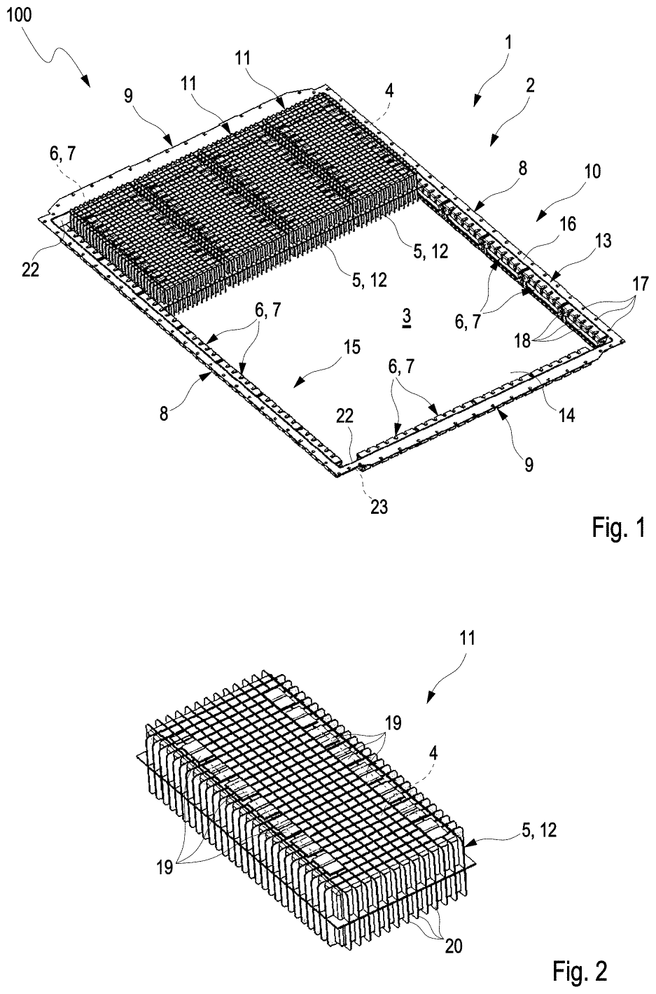

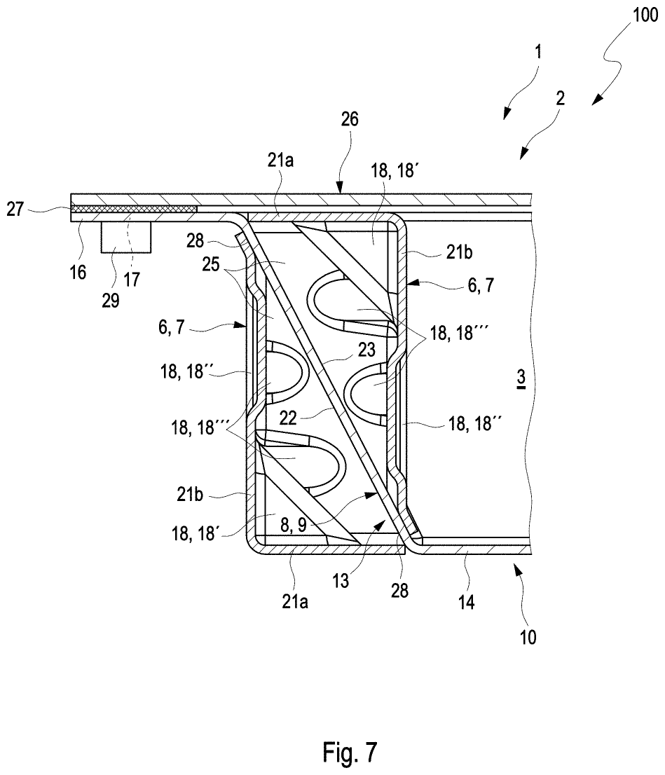

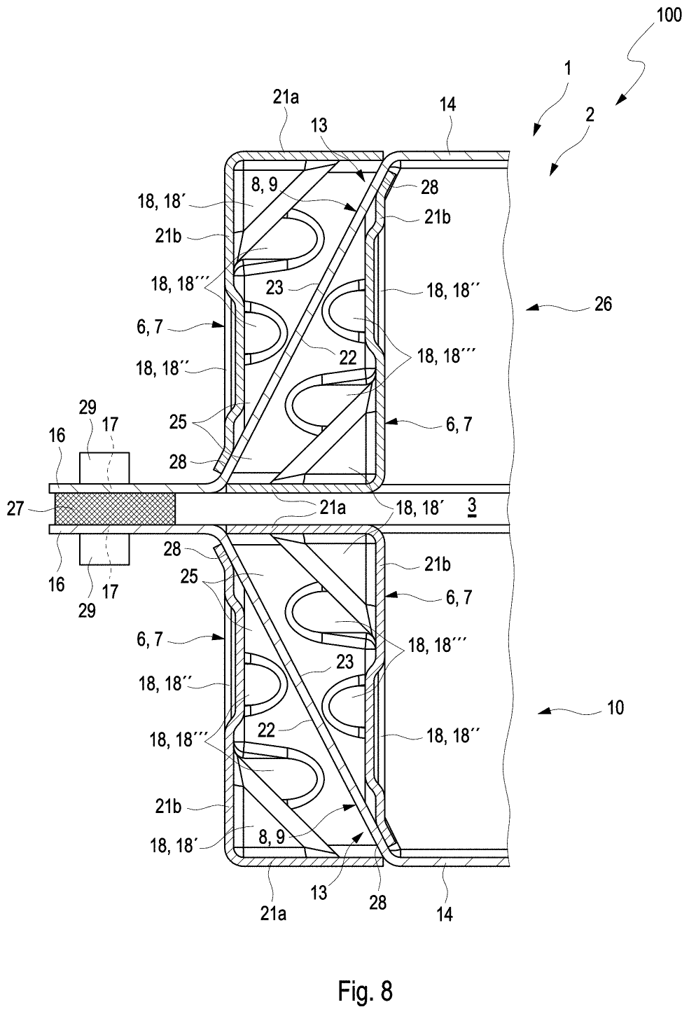

A battery system 1 as is shown in FIG. 1, for example, has a battery housing 2, or housing 2 for short, having a first housing part 10 and a second housing part 26 which is not illustrated in FIG. 1 (see FIGS. 7 and 8). The battery system 1 is in particular used in a vehicle 100, for example for driving the vehicle 100. The housing parts 10, 26 delimit an internal volume 3 in which rechargeable accumulator cells 4 are arranged and received. A plurality of accumulator cells 4 are in each case combined in one cell module 11. The accumulator cells 4 herein are not visible from the outside and not illustrated in FIGS. 1 and 2. A plurality of cell modules 11 are arranged and received in the internal volume 3, wherein for improved understanding of the construction of the battery housing 2 only part of the cell modules 11 are illustrated in FIG. 1. This means that, in addition to the four cell modules 11 illustrated, the entire housing part 10 can be populated with cell modules 11 so as to provide and receive as much energy as possible.

FIG. 2 shows such a cell module 11. The respective cell module 11 has a housing 5, hereunder also referred to as a module housing 5, in which the accumulator cells 4 are inserted and wired to one another by electrical contacts 19. The module housing 5 is advantageously produced from plastics material and is thus a plastics-material housing 12. The module housing 5 does not have to absorb any mechanical stress since the latter is ideally absorbed already by the first housing part 10 and not dissipated to the module housing 5.

The first housing part 10 in a manner corresponding to FIG. 1 is configured so as to be tray-shaped, wherein a lateral wall region 13 in an encircling manner adjoins a base region 14. The lateral wall region 13 in the examples shown has in each case two opposite walls 8, 9, specifically two opposite longitudinal walls 8 and two opposite transverse walls 9, so that the lateral wall region 13 is substantially quadrangular in the plan view. The respective wall 8, 9, and thus the lateral wall region 13, has an internal side 22 which faces the internal volume 3, and an external side 23 which faces away from the internal volume. The walls 8, 9 extend in the direction of the other housing part 26 which is not shown in FIG. 1 (see FIGS. 7 and 8). A separately embodied reinforcement structure 15 for reinforcing the tray-shaped first housing part 10 is arranged on the lateral wall region 13. The afore-mentioned absorption of mechanical stress by way of the first housing part 10 is improved by the reinforcement structure 15. The reinforcement structure 15 in the example shown extends on the lateral wall region 13 so as to encircle on the internal side, thus along the longitudinal walls 8 and the transverse walls 9, and is interrupted in corner regions between mutually adjacent walls 8, 9. The reinforcement structure 15 thus reinforces the entire lateral wall region 13.

The reinforcement structure 15 in the example shown has a plurality of separate segments 6, hereunder also referred to as segment elements 6, and is thus configured in segments. The segment elements 6 outside the corner regions of the first housing part 10 adjoin one another in a direct or equidistant manner and thus reinforce the entire lateral wall region 13. The segment elements 6 are configured as common parts 7 and can thus be produced in a simple and cost-effective manner. An encircling flange 16 which possesses numerous bores 17 distributed on the circumference is arranged on the end of the lateral wall region 13 that is arranged so as to be opposite the base region 14. Said bores 17 serve for connecting the two housing parts 10, 26 (see also FIGS. 7 and 8). The reinforcement structure 15, in particular the respective segment element 6, possesses corrugations 18 which increase the stability of the component, in particular the inherent stability and/or inherent rigidity, of the reinforcement structure 15, in particular of the respective segment element 6. The reinforcement structure 15 herein is arranged between the flange 16 and the base region 14. In the exemplary embodiment shown in FIG. 1 a plurality of the segment elements 6 are attached to the respective wall 8, 9. The longitudinal walls 8 and the transverse walls 9 have dissimilar extents so that a larger number of the segment elements 6 are attached to the longitudinal walls 8 than to the transverse walls 9.

As can be derived from FIG. 2, for example, the electrical contacts 19 which electrically connect the accumulator cells 4 which are arranged in the interior of the module housing 5 are plugged onto the plastics-material housing 12 to one another. Ribs 20 which reinforce the module housing 5 in such a manner that the fluid pressure which prevails in the module housing 11 and is caused by the accumulator cells 4 can be absorbed are arranged, in particularly moulded, on the external face of the module housing 5. Said ribs 20 of the module housing 5 can interact with the corrugations 18 of the reinforcement structure 15 in such a manner that the cell modules 11 are prevented from sliding out of position in the first housing part 10. At least part of the ribs 20 can in particular be push-fitted into respective associated corrugations 18 and thus, conjointly with the corrugations 18, form a form-fit.

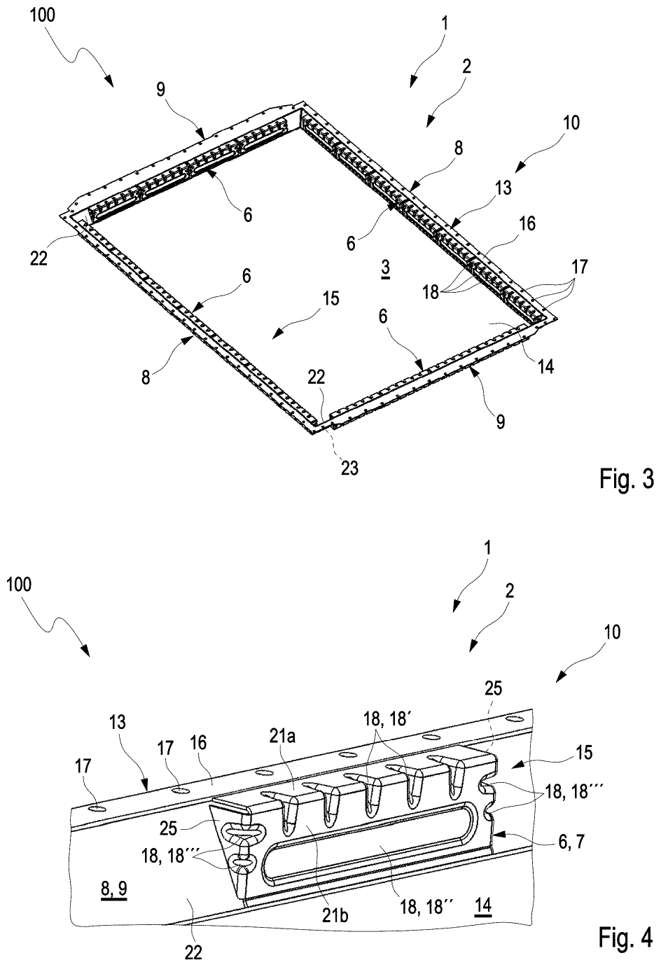

FIG. 3 shows the first housing part 10 of the battery housing 2 in another exemplary embodiment. As opposed to the reinforcement structure 15 illustrated in FIG. 1, only a single segment element 6 is arranged on and at attached to each wall 8, 9 of the lateral wall region 13 in this exemplary embodiment. Accordingly, the segment elements 6 arranged on the longitudinal walls 8, and the segment elements 6 arranged on the transverse walls 9, differ in particular in terms of their respective dimensions.

A single segment element 6 of the reinforcement structure 15 which is arranged on the lateral wall region 13 is illustrated in FIG. 4. This herein is a segment element 6 corresponding to the exemplary embodiment of FIG. 1. The segment elements 6 of the exemplary embodiment of FIG. 3 are configured in an analogous manner and have another extend only along the associated wall 8, 9.

It can be derived from FIGS. 1, 3, and 4 that the lateral wall region 13, and thus the walls 8, 9, between the base region 14 and the flange 16 run in an inclined manner such that the lateral wall region 13 is inclined away from the base region 14 and/or that the walls 8, 9 conjointly with the base region 14 form an obtuse angle of more than 90°, for example more than 100°, in particular between 100° and 120°.

As can be derived in particular from FIG. 4, the respective segment element 6, and thus the reinforcement structure 15, has a first leg 21a and a second leg 21b. The first leg 21a adjoins the lateral wall region 13 in the region of the flange 16. The second leg 21b contacts the lateral wall region 13 close to the transition towards the base region 14. The legs 21a, 21b in the example shown in close a right angle of 90°, wherein the length of the legs 21a, 21b is conceived with a view to the gradient and thus to the inclined profile of the lateral wall region 13, in particular of the associated wall 8, 9. The segment element 6 has corrugations 18 which in the transition region of the legs 21a, 21b engage in the first leg 21a as well as in the second leg 21b and are thus in each case configured as a depression. In addition to said corrugations 18 which hereunder are also referred to as longitudinal corrugations 18′, a corrugation 18 which runs in an oval manner and is configured as a depression and hereunder is also referred to as a width corrugation 18″, is arranged in the second leg 21b. The segment element 15, in additional to the legs 21a, 21b, has two triangular regions 25 which are opposite on the second leg 21b and adjoin the second leg 21b and project in the direction of the associated wall 8, 9 and which bear on the associated wall 8, 9 and thus enable an almost encircling contact between the segment element and the associated wall 8, 9 and thus with the lateral wall region 13. The segment element 6 herein has further corrugations 18 which are in each case configured as a depression and in the transition region between the second leg 21b and the triangular regions 25 engage in the second leg 21b and the triangular regions 25 and hereunder are also referred to as transverse corrugations 18′″. The transverse corrugations 18′″ in the example shown along the extent of the associated wall 8, 9 are spaced apart from the width corrugation 18″.

The reinforcement structure 15 in the example shown in FIGS. 1, 3, and 4 are arranged on the internal side 22 of the lateral wall region 13. This means that the respective segment element 6 is arranged on the internal side 22 of the associated wall 8, 9.

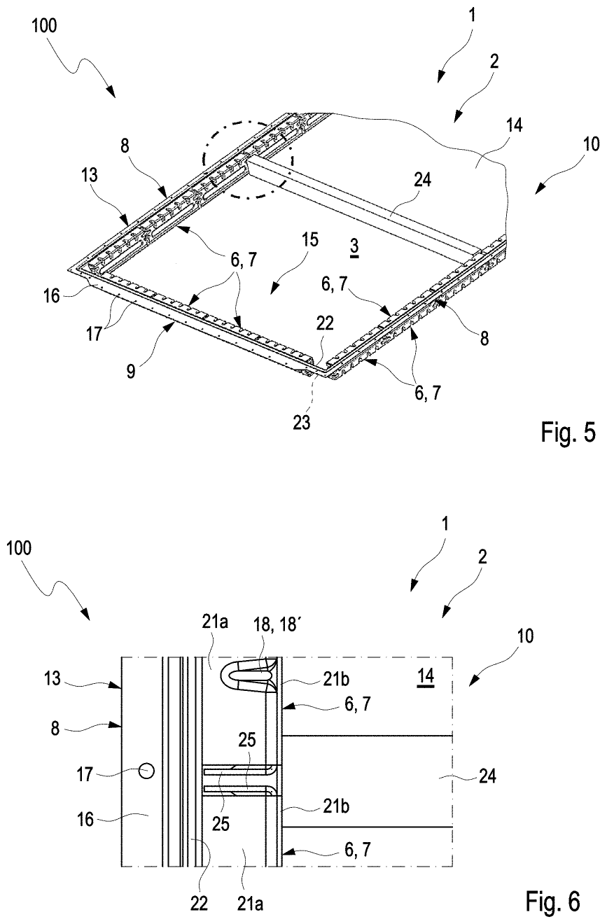

As can be derived from FIG. 5, in addition to said segment elements 6, further segment elements 6 can be arranged on the external side 23 of the lateral wall region 13. In this case, the reinforcement structure 15 is thus arranged on the internal side 22 as well as on the external side 23. While not illustrated here, it is also conceivable for the reinforcement structure 15, or the segment elements 6, respectively, to be arranged only on the external side 23. The segment elements 6 herein can at least in part be configured as common parts 7.

It can furthermore be seen in FIGS. 5 and 6 that transverse support 24 for increasing the rigidity of the component of the battery housing 2 is attached between two walls 8, 9 of the lateral wall region 13 which are arranged opposite one another, in this example between the longitudinal walls 8. According to this exemplary embodiment, the transverse support 24 adjoins the reinforcement structure 15 on the internal side, in the shown example adjoins segment elements 6 which are arranged on the internal side 22. The transverse support 24 herein is position in such a manner that said transverse support 24 by way of the respective end side thereof is arranged in the region between two successive segment elements 6 and bears on said segment elements 6, in particular on the associated second legs 21b. This detail can be derived in particular from FIG. 6, wherein FIG. 6 shows a plan view onto the region indicated by a dashed circle in FIG. 5.

A fragment of a battery housing 2 is illustrated in the section in FIG. 7. The battery housing 2, apart from the first housing part 10, possesses a second housing part 26 which in this exemplary embodiment is configured as a flat plate. A seal 27 is arranged between the first housing part 10 and the second housing part 26. The housing parts 10, 26 are thus connected to one another so as to be tight in relation to the outside. In this exemplary embodiment the first housing part 26 corresponds to the example shown in FIG. 5, wherein the transverse support 24 can be dispensed with. The reinforcement structure 15 has segment elements 6 which are arranged on the internal side 22 as well as segment elements 6 which are arranged on the external side 23. The segment element 6 which is visible in FIG. 7 and arranged on the internal side 22, like the other segment elements 6 arranged on the internal side 22, is preferably welded to the lateral wall region 13, or to the associated wall 8, 9, respectively, in a portion close to the base region 14, also referred to as a base-proximal region. This connection may be configured as a spot-welded seam 28. However, other types of connections can of course also be used at this location. The segment element 6 which is visible in FIG. 7 and arranged on the external side 23, preferably like the other segment elements 6 arranged on the external side 23, is connected to the external side 23 in the same manner, wherein the segment elements 6 are common parts 7 and in terms of the associated wall 8, 9 are arranged in a mirror-symmetrical manner. Furthermore in FIG. 7, a connection element 29 is routed through one of the breakouts 17 in the flange 16 of the first housing part 10, so as to connect the housing parts 10, 26 to one another, in particularly by configuring a screw connection. The seal 27 bears on a sealing face of the respective housing part 10, 26, said sealing face not being referenced in more detail. In the case of the housing part 10, 26 having the flange 16, thus presently in the case of the first housing part 10, the sealing face is configured on the flange 16. It can furthermore be seen that the seat 27 as well as the sealing faces are arranged so as to be spaced apart and offset from the reinforcement structure 15.

An alternatively designed battery housing 2 is illustrated in FIG. 8. As opposed to the battery housing 2 illustrated in FIG. 7, the second housing part 26 is likewise designed so as to be tray-shaped and, in a manner analogous to the first housing part 10, thus has an encircling lateral wall region 13 which is adjoined by a base region 14, wherein an encircling flange 16 which possesses numerous bores 17 which are distributed on the circumference is arranged on the end of the lateral wall region 13 that is opposite the base region 14. The first housing part 10 thus corresponds in particular to the second housing part 26. The housing parts 10, 26, while using the seal 27, are connected to one another by way of associated connection elements 29, in particular so as to configure in each case one screw connection.

1. The battery housing, comprising:
a first housing part and a second housing part;
the first housing part and the second housing part connectable to one another in a sealing manner;
at least one housing part of the first housing part and the second housing part including a base region and a lateral wall region that adjoins the base region such that the at least one housing part is tray-shaped;
the lateral wall region having an internal side and an external side;
an encircling flange arranged on the lateral wall region of the at least one housing part; and
wherein a separately structured reinforcement structure is arranged on the lateral wall region between the flange and the base region.

2. The battery housing according to claim 1, wherein the reinforcement structure, at least in part, is arranged on the internal side of the lateral wall region.

3. The battery housing according to claim 1, wherein the reinforcement structure, at least in part, is arranged on the external side.

4. The battery housing according to one of claim 1, wherein the reinforcement structure is structured in segments and includes at least two separate segment elements.

5. The battery housing according to claim 4, wherein the at least two segment elements are configured as common parts.

6. The battery housing according to claim 1, wherein the reinforcement structure includes a plurality of corrugations.

7. The battery housing according to one of claim 1, wherein the reinforcement structure is connected in a non-releasable manner to the lateral wall region.

8. The battery housing according to claim 1, wherein the at least one housing part and the reinforcement structure are composed of the same material.

9. The battery housing according to claim 1, wherein the reinforcement structure includes two legs which are arranged at an angle relative to one another.

10. The battery housing according to claim 9, wherein:
the lateral wall region extends at an angle of more than 90° relative to the base region; and
the reinforcement structure is configured such that one of the two legs is arranged perpendicular to the base region.

11. A battery system, comprising a battery housing and at least two accumulator cells configured to receive and discharge electric energy arranged in the battery housing, the battery housing including:
a first housing part and a second housing part;
the first housing part and the second housing part connectable to one another in a sealing manner;
at least one housing part of the first housing part and the second housing part including a base region and a lateral wall region that adjoins the base region such that the at least one housing part is tray-shaped;
the lateral wall region having an internal side and an external side;
an encircling flange arranged on the lateral wall region of the at least one housing part; and
wherein a separately structured reinforcement structure is arranged on the lateral wall region between the flange and the base region.

12. The battery system according to claim 11, further comprising at least one cell module including a module housing, wherein:
the at least one cell module is arranged in the battery housing;
the at least two of the accumulator cells are received in the module housing; and
the module housing is a plastics-material housing.

13. The battery system according to claim 12, further comprising a plurality of ribs structured and arranged to reinforce the module housing, wherein:
the plurality of ribs are arranged on an external face of the module housing;
the reinforcement structure includes a plurality of corrugations; and
at least a portion of the plurality of ribs are push-fitted into the plurality of corrugations.

14. The battery housing according to claim 1, wherein the reinforcement structure is non-releasably connected to the lateral wall region via at least one of a welded connection, an adhesively bonded connection, and a riveted connection.

15. The battery housing according to claim 1, wherein:
the base region and the flange are disposed on opposite ends of the lateral wall region; and
the lateral wall region extends between the base region and the flange region in an inclined manner such that the base region and the lateral wall region define an obtuse angle.

16. The battery housing according to claim 9, wherein:
the two legs includes a first leg and a second leg that are connected to one another in a transition region; and
the reinforcement structure includes a plurality of longitudinal corrugations disposed in the transition region and at least one width corrugation disposed in the second leg.

17. The battery housing according to claim 16, wherein:
the reinforcement structure further includes two side regions disposed on opposite sides of the two legs and connected to the two legs;
the two side regions contact the lateral wall region of the at least one housing part; and
the reinforcement structure further includes a plurality of transverse corrugations disposed in a second transition region in which the second leg is connected to one of the two side regions.

18. The battery housing according to claim 9, wherein a base-proximal leg of the two legs is arranged perpendicular to the base region.

19. The battery housing according to claim 9, wherein:
a first leg of the two legs is arranged perpendicular to the base region; and
a second leg of the two legs adjoins the lateral wall region in a region of the flange.

20. The battery housing, comprising:
a first housing part and a second housing part;
the first housing part and the second housing part connectable to one another in a sealing manner;
the first housing part including a base region and a lateral wall region that adjoins and encircles the base region;
the first housing part further including two opposing longitudinal walls and two opposing transverse walls forming the lateral wall region such that the at least one housing part is tray-shaped and defines an internal volume;
the lateral wall region having an internal side facing the internal volume and an external side facing away from the internal volume;
an encircling flange arranged on the lateral wall region of the at least one housing part; and
wherein a separately structured reinforcement structure is arranged on the lateral wall region between the flange and the base region.
